(19) United States
(12) Patent Application Publication
(10) Pub. No.: US 2003/0206534 A1
(43) Pub. Date: Nov. 6, 2003

(54) Scheme to handle radio link control service data units upon reception of a radio link control reset or reset acknowledge protocol data unit in a wireless communication system

(76) Inventor: Frank Chih-Hsiang Wu, Shindian City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/320,486

(22) Filed: Dec. 17, 2002

Related U.S. Application Data
(60) Provisional application No. 60/377,228, filed on May 3, 2002.

(51) Int. Cl. H04Q 7/00

(52) U.S. Cl. 370/328

(57) ABSTRACT

The present invention provides a scheme for handling a radio link control reset protocol data unit (RLC RESET PDU) or reset acknowledge protocol data unit (RESET ACK PDU) in a wireless communication system. Depending upon certain criteria, upon reception of RLC RESET PDU or RESET ACK PDU, the RLC receiver may or may not discard RLC SDUs that were transmitted or were not transmitted before the reset or re-establishment in the transmitting side of the AM RLC entity. Additionally, the first compressed packet type after an RLC reset is a full header or compressed TCP with no delta. Since a proper handling scheme is disclosed, data loss is prevented, compressed data are successfully decompressed, unnecessary retransmissions are avoided, and wasting of system resources is reduced. Therefore, system performance of a wireless communication system is improved.

### REFERENCE TO RELATED APPLICATION

This patent application is based upon Provisional Patent Application Serial No. 60/377,228, filed May 3, 2002, entitled “Erroneous Packet Data Convergence Protocol Data Unit Handling Scheme in a Wireless Communication System.

### BACKGROUND OF THE INVENTION

1. Field of the Invention

The present invention relates to a wireless communications protocol. More specifically, the present invention discloses a scheme for handling a radio link control (RLC) reset protocol data unit (RESET PDU) or an RLC reset acknowledge protocol data unit (RESET ACK PDU) in a wireless communication system.

2. Description of the Prior Art

Wireless communication systems have evolved rapidly. New wireless communication methods, services and standards have been developed throughout the world. Particularly over the last few years, this evolution has accelerated, during which the mobile radio communications industry has grown by orders of magnitude. Numerous technological advances that have made portable radio equipment smaller, cheaper and more reliable. The exponential growth of mobile telephony will continue to rise in the coming decades as well, as this wireless network interacts with and eventually overtakes the existing wireline networks.

Conventional wireline systems provide a communications path between the source and the destination. This technique establishes a connection or allocation of system resources between a base station and mobile terminal. Although such connections are useful in maintaining voice communications, data transmissions are often followed by lengthy periods of inactivity, resulting in a waste of resources.

Additionally, system resources may be wasted due to unnecessary discarding of data or unnecessary retransmission of data. Furthermore, wireless communication system integrity may be compromised due to data loss or synchronization problems. Therefore, there is need for an improved communication protocol which reduces wasting of system resources and improves wireless communication system performance.

### SUMMARY OF THE INVENTION

To achieve advantages and in order to overcome the disadvantages of the conventional method in accordance with the purpose of the invention as embodied and broadly described herein, the present invention discloses a method for specifying actions for handling an RLC RESET PDU or an RLC RESET ACK PDU which thereby improves wireless communication system performance and reduces wasting of system resources.

Packet Data Convergence Protocol (PDCP) provides its services to the upper layers. PDCP performs the following functions: header compression and decompression of IP data streams at the transmitting and receiving entity respectively, transfer of user data, and maintenance of PDCP sequence numbers for radio bearers that are configured to support lossless serving radio network subsystem (SRNS) Relocation. PDCP uses the services provided by the Radio Link Control (RLC) sub layer.

Lossless SRNS Relocation is only applicable when an RLC is configured for in-sequence delivery and acknowledged mode (AM). The support of lossless SRNS Relocation is configured by an upper layer. PDCP sequence numbering is applied when lossless SRNS Relocation is supported. PDCP Sequence Numbers (SN) serve to acknowledge previously transmitted PDCP service data units (SDUs) prior to relocation. The value of the PDCP sequence number ranges from 0 to 65535. The PDCP SN window size indicates the maximum number of PDCP SDUs, not confirmed to have been successfully transmitted to the peer entity by RLC layer, that can be numbered at any given time. The PDCP SN window size is configured by upper layers. PDCP sequence numbers are set to “0” when the PDCP entity is set-up for the first time.

An RLC reset procedure is used to reset two RLC peer entities, which are operating in acknowledged mode. During the reset procedure the hyper frame numbers (HFN) in universal mobile telecommunications system terrestrial radio access network (UTRAN) and user equipment (UE) are synchronised. Two HFNs used for ciphering need to be synchronised, downlink HFN (DL HFN) in downlink and uplink HFN (UL HFN) in uplink. In the reset procedure, the highest UL HFN and DL HFN used by the RLC entity in the transmitting sides, i.e. the HFNs associated with acknowledged mode data (AMD) PDUs of “Sequence Number”=VT(S)−1 if at least one AMD PDU had been transmitted or of “Sequence Number”=0 if no AMD PDU had been transmitted, are exchanged between the UE and UTRAN. The RESET PDUs and the RESET ACK PDUs have higher priority than AMD PDUs.

Currently, appropriate actions are not properly or fully specified for a radio link control (RLC) reset protocol data unit (RESET PDU) or an RLC reset acknowledge protocol data unit (RESET ACK PDU) in a wireless communication system. Since appropriate actions are not specified, data can be lost, system resources are often wasted, compressed data can not be successfully decompressed, and unnecessary retransmissions are made.

Therefore, there is need for an improved scheme for efficiently handling actions taken so that inappropriate actions are avoided, errors are reduced, system resources are not wasted, and wireless communication system performance is improved.

Therefore, the present invention provides a method for specifying actions for handling an RLC RESET PDU or an RLC RESET ACK PDU which thereby improves wireless communication system performance and reduces wasting of system resources.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a diagram illustrating an elementary RLC reset procedure as defined by the 3rd Generation Partnership Project (3GPP) specification 3GPP TS 25.322 V3.12.0 “RLC protocol specification”, which is included herein by reference; and

FIG. 2 is a diagram illustrating the protocol format of PDCP PDU's as defined by the 3rd Generation Partnership Project (3GPP) specification 3GPP TS 25.323 V3.10.0 “Packet Data Convergence Protocol (PDCP) Specification”, which is included herein by reference in a wireless communication system.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

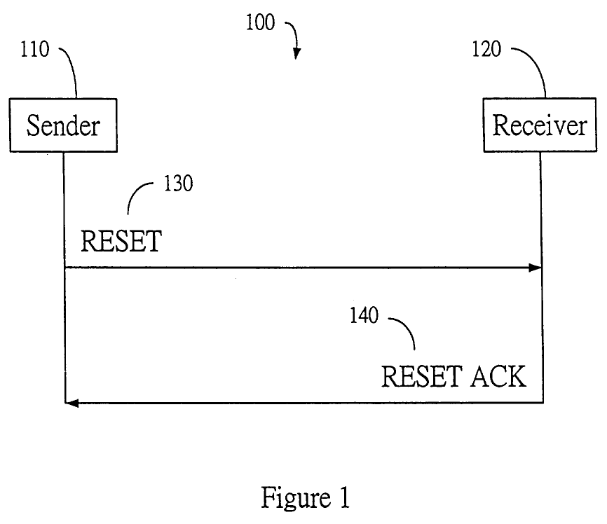

Refer to FIG. 1, which is a diagram illustrating an elementary RLC reset procedure 100. Basically, a sender 110 sends a RESET PDU 130 to a receiver 120. The receiver 120, should respond with a RESET ACK PDU 140 to the sender 110.

An RLC reset procedure is used to reset two RLC peer entities, which are operating in acknowledged mode. During the reset procedure the hyper frame numbers (HFN) in the UTRAN and UE are synchronised. Two HFNs used for ciphering need to be synchronised, DL HFN in downlink and UL HFN in uplink. In the reset procedure, the highest UL HFN and DL HFN used by the RLC entity in the transmitting sides, i.e. the HFNs associated with AMD PDUs of “Sequence Number”=VT(S)−1 if at least one AMD PDU had been transmitted or of “Sequence Number”=0 if no AMD PDU had been transmitted, are exchanged between the UE and UTRAN. The RESET PDUs and the RESET ACK PDUs have higher priority than AMD PDUs.

Triggers that will result in an initiation procedure are, if “No_Discard after MaxDAT number of retransmissions” is configured and VT(DAT) equals the value MaxDAT; or if VT(MRW) equals the value MaxMRW; or if a STATUS PDU including “erroneous Sequence Number” is received.

If one of these triggers is detected, the sender will, stop transmitting any AMD PDU or STATUS PDU; submit a RESET PDU to the lower layer; and start the timer Timer_RST and increase VT(RST) with 1.

If the TFC selection exchange has been initiated by sending the RLC Entity Info parameter to the medium access control (MAC), the RLC entity may delay the RLC reset procedure until the end of the next transmission time interval (TTI).

When a reset procedure has been initiated it can only be ended upon reception of a RESET ACK PDU with the same RSN value as in the corresponding RESET PDU, or upon request of re-establishment or release from upper layers, a reset procedure is not interrupted by the reception of a RESET PDU from the peer entity.

When RESET PDU contents are to be set, the sender will set the HFNI field to the currently highest used HFN (DL HFN when the RESET PDU is sent by UTRAN or UL HFN when the RESET PDU is sent by the UE) and set the RSN field to the sequence number of the RESET PDU. The sequence number of the first RESET PDU after the AM entity is established or re-established shall be “0”. This sequence number is incremented every time a new RESET PDU is transmitted, but not when a RESET PDU is retransmitted.

Upon reception of a RESET PDU the receiver will perform the following. If the RSN value in the RESET PDU is the same as the RSN value in the last received RESET PDU, the receiver will either only submit a RESET ACK PDU to the lower layer with the contents set exactly as in the last transmitted RESET ACK PDU (i.e., in this case the RLC entity is not reset); or perform the actions specified below as if the RSN value was different from the RSN value in the last received RESET PDU.

Otherwise, if the RESET PDU is the first RESET PDU received since the entity was (re-)established or the RSN value is different from the RSN value in the last received RESET PDU, the receiver will submit a RESET ACK PDU to the lower layer with the content set; reset the state variables except VT(RST) to their initial values; stop all the timers except Timer_RST; reset configurable parameters to their configured values; discard all RLC PDUs in the receiving side of the AM RLC entity; discard all RLC SDUs that were transmitted before the reset in the transmitting side of the AM RLC entity; set the HFN (DL HFN when the RESET PDU is received in UE or UL HFN when the RESET PDU is received in UTRAN) equal to the HFNI field in the received RESET PDU; increase with one the UL HFN and DL HFN, and the updated HFN values shall be used for the first transmitted and received AMD PDUs after the reset procedure.

If the TFC selection exchange has been initiated by sending the RLC Entity Info parameter to MAC, the RLC entity may delay the RLC SDUs discard in the transmitting side of the AM RLC entity until the end of the next TTI.

The RESET ACK PDU contents to set are as follows. The receiver will set the hyper frame number indicator field (HFNI) to the currently highest used HFN (DL HFN when the RESET ACK PDU is sent by UTRAN or UL HFN when the RESET ACK PDU is sent by the UE) and set the RSN field to the same value as in the corresponding received RESET PDU.

Upon reception of a RESET ACK PDU, the sender will perform the following. If the sender has already transmitted a RESET PDU which has not been yet acknowledged by a RESET ACK PDU and if the received RSN value is the same as the one in the corresponding RESET PDU, the sender will set the HFN value (DL HFN when the RESET ACK PDU is received in UE or UL HFN when the RESET ACK PDU is received in UTRAN) to the HFNI field of the received RESET ACK PDU; reset the state variables to their initial values; stop all the timers; reset configurable parameters to their configured values; discard all RLC PDUs in the receiving side of the AM RLC entity; discard all RLC SDUs that were transmitted before the reset in the transmitting side of the AM RLC entity; and increase with one the UL HFN and DL HFN, and the updated HFN values shall be used for the first transmitted and received AMD PDUs after the reset procedure.

Otherwise, if the received RSN value is not the same as the one in the corresponding RESET PDU, the sender will discard the RESET ACK PDU.

If the sender has not transmitted a RESET PDU which has not been yet acknowledged by a RESET ACK PDU, the sender will discard the RESET ACK PDU.

If the TFC selection exchange has been initiated by sending the RLC Entity Info parameter to MAC, the RLC entity may delay the RLC SDUs discard in the transmitting side until the end of the next TTI.

The upper layers may re-establish an RLC entity. The RLC re-establishment function is applicable for acknowledged mode (AM) and unacknowledged mode (UM) and is used when upper layers request an RLC entity to be re-established.

When an RLC entity is re-established by upper layers, the RLC entity will reset the state variables to their initial value; set the configurable parameters to their configured value; and set the hyper frame number (HFN) in UL and DL to the value configured by upper layers.

If the RLC entity is operating in unacknowledged mode and if it is a receiving UM RLC entity, the RLC entity will discard all unacknowledged mode data (UMD) PDUs.

If the RLC entity is operating in unacknowledged mode and if it is a transmitting UM RLC entity, the RLC entity will discard the RLC SDUs for which one or more segments have been submitted to a lower layer.

Otherwise, if the RLC entity is operating in acknowledged mode, the RLC entity will discard all AMD PDUs and control PDUs in both the receiving side and the transmitting side of the RLC entity.

If the TFC selection exchange has been initiated by sending the RLC Entity Info parameter to MAC, the RLC entity may delay the re-establishment function until the end of the next TTI.

For radio bearers that are configured to support lossless SRNS Relocation, the PDCP entity will perform as follows. If the upper layer indicates to a PDCP entity that it should synchronise the PDCP SN following a RLC reset or RLC re-establishment not caused by a SRNS Relocation or if the UE/UTRAN PDCP entity receives an invalid “next expected UL/DL Receive PDCP sequence number” from the upper layer after Relocation, the PDCP entity will trigger the PDCP SN synchronisation procedure by submitting one PDCP SeqNum PDU to the lower layer, and consider that the synchronisation procedure is complete on confirmation by the lower layer of the successful transmission of the PDCP SeqNum PDU.

However, in various situations and conditions, unspecified or improper actions during or after an RLC reset procedure may result in serious problems for the wireless communication system. These problems include wasted system resources, data loss, unnecessary retransmissions, and unsuccessful data decompression.

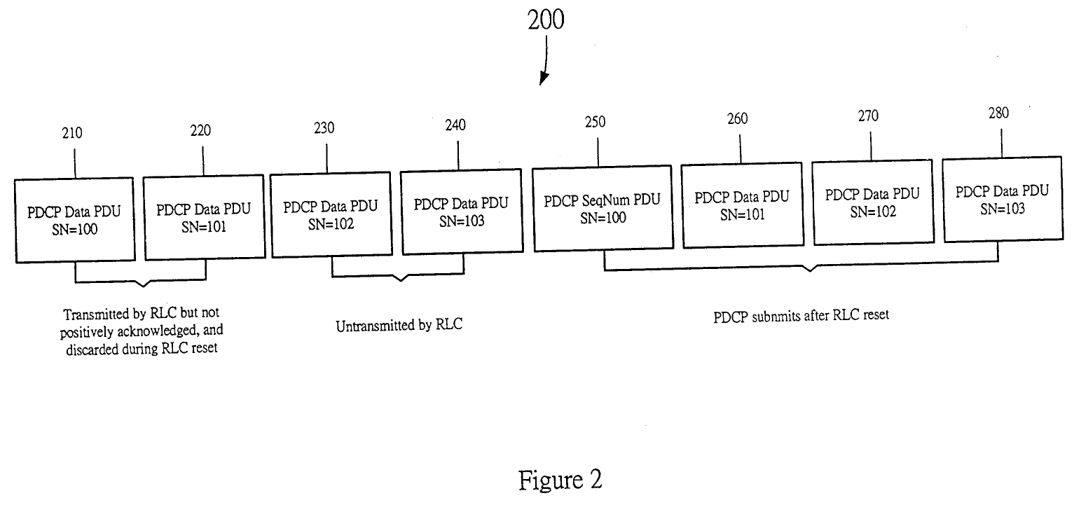

For greater understanding of the potential system problems, the following scenario is given for example. For clarity, refer to FIG. 2, which is a diagram illustrating the PDCP PDU protocol format 200.

Consider a radio bearer configured to support lossiess SRNS Relocation. The PDCP entity submits PDCP Data PDUs with Sequence Number (SN)=100 (210), 101 (220), 102 (230), and 103 (240) to the RLC. When conditions for an RLC reset are fulfilled, the RLC reset procedure is triggered.

At this time, PDCP Data PDU with SN=100 (210) and 101 (220) have been transmitted by the transmitting side of AM RLC entity but have not been positively acknowledged. According to the conventional method, the RLC receiver discards all RLC SDUs that were transmitted before the reset in the transmitting side of the AM RLC entity and an RLC SDU contains a PDCP PDU so PDCP Data PDU with SN=100 (210) and 101 (220) are discarded in the RLC buffer. The upper layer indicates to a PDCP entity that it should synchronize the PDCP SN following a RLC reset. Therefore, the PDCP entity triggers the PDCP SN synchronization procedure by submitting one PDCP SeqNum PDU to the lower layer. Because the smallest SN is 100, the PDCP entity submits a PDCP SeqNum PDU with SN 100 (250) containing the same data as PDCP Data PDU with SN=100. PDCP Data PDUs with SN=101 (260), 102 (270), and 103 (280) are also submitted to the RLC again.

Utilizing the above scenario, the following examples are given to illustrate possible problems that can occur.

For a first example, if RLC SDUs (PDCP Data PDUs with SN=102 and 103) that were not transmitted are not discarded, PDCP Data PDUs with SN=102 and 103 are transmitted twice. As a result of this retransmission, radio resources are wasted.

For a second example, consider that header compression is applied and the data part in PDCP Data PDUs with SN=100, 101, 102, and 103 are compressed transmission control protocol (TCP) packets. The header compression context of the decompressor is updated if the compressed data in the PDCP Data PDU is a compressed TCP packet and is decompressed successfully. The compressed TCP packet is a packet with a compressed TCP header, containing a CID, a flag octet identifying what fields have changed, and the changed fields (e.g. sequence number) encoded as the difference from the previous value. For example, for the sequence number field in TCP packet, if no TCP packets are lost in compression, the sequence number in the compressed TCP is encoded as the amount of data in the previous TCP packet. The difference for TCP sequence number is positive.

Now, the RLC reset procedure is triggered and PDCP Data PDU with SN=100 and 101 are discarded. PDCP Data PDUs with SN=100 and 101 have been transmitted, but the receiving side of the peer RLC entity may or may not have received them correctly. Suppose that PDCP Data PDUs with SN=100 and 101 were not received correctly and RLC SDUs (PDCP Data PDUs with SN=102 and 103) that were not transmitted are not discarded. After RLC reset, PDCP Data PDUs with SN=102 and 103 are transmitted first.

Because PDCP Data PDUs with SN=100 and 101 are lost, the header compression context in the decompressor in the PDCP receiver is not updated. The decompressor may compute the TCP checksum to determine if its context is not updated properly. If the checksum fails, the error is assumed to be caused by a lost segment that did not update the context properly. Therefore, if no mechanisms are applied, compressed TCP packets in PDCP Data PDUs with SN=102 and 103 are not decompressed successfully. An algorithm is used to repair the header compression context of the decompressor. The delta of the current segment is then added to the context again on the assumption that the lost segment contained the same delta as the current. By decompressing and computing the TCP checksum again, the decompressor checks if the repair succeeded or if the delta should be applied once more.

Because only two compressed TCP packets were lost, the algorithm should be able to used to decompress compressed TCP packets in PDCP Data PDUs with SN=102 and 103 successfully. Therefore, the header compression context of the decompressor is updated properly. The header compression context is updated according to fields in compressed TCP packets in PDCP Data PDUs with SN=102 and 103. Because the difference between changed fields in the current packet and the previous packet are positive, compressed TCP packets in PDCP SeqNum PDU with SN=100 and in PDCP Data PDU with SN=101 are not decompressed successfully and are lost forever. PDCP Data PDUs with SN=102 and 103 transmitted at the second time are not decompressed successfully. Moreover, the PDCP receiver sends context state packets to request the header compressor context of the PDCP sender due to the unsuccessful decompression. The PDCP sender sends its context contained in a packet (called full header packet) to the PDCP receiver. Transmission of context state packets and full header packets waste radio resources.

For a third example, consider that a radio bearer is configured not to support lossless SRNS Relocation. The PDCP entity submits PDCP Data PDUs with Sequence Number (SN)=100, 101, 102, and 103 to the RLC. PDCP Data PDU with SN=100 and 101 has been transmitted by the transmitting side of AM RLC entity but not positively acknowledged.

Now, conditions for an RLC reset are fulfilled, and the RLC reset procedure is triggered. According to the conventional method, the RLC receiver discards all RLC SDUs that were transmitted before the reset in the transmitting side of the AM RLC entity. Therefore, PDCP Data PDU with SN=100 and 101 are discarded in the RLC buffer.

In the conventional method, how to handle RLC SDUs that were not transmitted before the reset in the transmitting side of the AM RLC entity is not specified. If RLC SDUs that were not transmitted before the reset in the transmitting side of the AM RLC entity are discarded, those RLC SDUs are lost forever because the PDCP entity does not retransmit them.

For a fourth example, consider that an AM radio bearer is configured not to support lossless SRNS Relocation. The PDCP entity submits PDCP Data PDUs with SN=100, 101, 102, and 103 to the RLC. PDCP Data PDUs with SN=100 and 101 have been transmitted by the transmitting side of AM RLC entity but have not been positively acknowledged. Now, the RLC entity is re-established. According to the conventional method, the RLC entity discards all RLC PDUs and control PDUs so PDCP Data PDUs with SN=100, 101, 102, and 103 are discarded in the RLC buffer. PDCP Data PDUs with SN=102 and 103 are lost forever because the PDCP entity does not retransmit them.

For a fifth example, consider an UM radio bearer. The PDCP entity submits PDCP Data PDUs with SN=100, 101, 102, and 103 to the RLC. PDCP Data PDUs with SN=100 and 101 have been transmitted by the transmitting side of the RLC entity. Now, the RLC entity is re-established. According to the conventional method, the RLC entity discards the RLC SDUs for which one or more segments have been submitted to a lower layer so that PDCP Data PDUs with SN=100 and 101 are discarded in the RLC buffer. PDCP Data PDUs with SN=100 and 101 may not have been received correctly. If PDCP Data PDUs with SN=100 and 101 are not received correctly, they are lost forever.

As shown in the examples above, serious problems such as data loss, wasted system resources, or unnecessary retransmissions, can occur when inappropriate actions are taken or unspecified actions are not taken during or after an RLC reset procedure.

Therefore, there is need for an improved scheme for efficiently handling actions taken so that inappropriate actions are avoided, errors are reduced, system resources are not wasted, and wireless communication system performance is improved.

Therefore, the present invention provides a method for specifying actions for handling an RLC RESET PDU or an RLC RESET ACK PDU which thereby improves wireless communication system performance and reduces wasting of system resources.

In an embodiment of the present invention, upon reception of an RLC RESET PDU or an RLC RESET ACK PDU, the RLC receiver discards all RLC SDUs that were transmitted or were not transmitted before the reset in the transmitting side of the AM RLC entity. This embodiment of the present invention solves at least the problems of examples 1 and 2.

Referring back to the first example above, if RLC SDUs (PDCP Data PDUs with SN=102 and 103) that were not transmitted are not discarded, PDCP Data PDUs with SN=102 and 103 are transmitted twice. As a result of this retransmission, radio resources are wasted.

However, utilizing an embodiment of the present invention, upon reception of an RLC RESET or RESET ACK PDU, the RLC receiver discards all RLC SDUs that were transmitted or were not transmitted before the reset in the transmitting side of the AM RLC entity. Therefore, unnecessary retransmissions are avoided, thus saving radio resources and improving performance.

Referring back to the second example above, because only two compressed TCP packets were lost, the algorithm should be able to used to decompress compressed TCP packets in PDCP Data PDUs with SN=102 and 103 successfully. Therefore, the header compression context of the decompressor is updated properly. The header compression context is updated according to fields in compressed TCP packets in PDCP Data PDUs with SN=102 and 103. Because the difference between changed fields in the current packet and the previous packet is positive, compressed TCP packets in PDCP SeqNum PDU with SN=100 and in PDCP Data PDU with SN=101 are not decompressed successfully and are lost forever. PDCP Data PDUs with SN=102 and 103 transmitted at the second time are not decompressed successfully. Moreover, the PDCP receiver sends context state packets to request the header compressor context of the PDCP sender due to the unsuccessful decompression. The PDCP sender sends its context contained in a packet (called full header packet) to the PDCP receiver. Transmission of context state packets and full header packets waste radio resources.

However, utilizing an embodiment of the present invention, upon reception of an RLC RESET PDU or an RLC RESET ACK PDU, the RLC receiver discards all RLC SDUs that were transmitted or were not transmitted before the reset in the transmitting side of the AM RLC entity. Therefore, unnecessary transmissions of context state packets and full header packets are avoided and data are not lost, thus saving radio resources and improving performance.

In another embodiment of the present invention, the first compressed packet type after an RLC reset is a full header or compressed TCP with no delta. This embodiment of the present invention solves at least the problems of example 2.

Referring back to the second example above, because only two compressed TCP packets were lost, the algorithm should be able to used to decompress compressed TCP packets in PDCP Data PDUs with SN=102 and 103 successfully. Therefore, the header compression context of the decompressor is updated properly. The header compression context is updated according to fields in compressed TCP packets in PDCP Data PDUs with SN=102 and 103. Because the difference between changed fields in the current packet and the previous packet is positive, compressed TCP packets in PDCP SeqNum PDU with SN=100 and in PDCP Data PDU with SN=101 are not decompressed successfully and are lost forever. PDCP Data PDUs with SN=102 and 103 transmitted at the second time are not decompressed successfully. Moreover, the PDCP receiver sends context state packets to request the header compressor context of the PDCP sender due to the unsuccessful decompression. The PDCP sender sends its context contained in a packet (called full header packet) to the PDCP receiver. Transmission of context state packets and full header packets waste radio resources.

However, utilizing an embodiment of the present invention, the first compressed packet type after an RLC reset is a full header or compressed TCP with no delta. Therefore, unnecessary transmissions of context state packets and full header packets are avoided, compressed data are successfully decompressed, and data are not lost, thus saving radio resources and improving performance.

In another embodiment of the present invention, for a radio bearer configured to support lossless SRNS Relocation, upon reception of an RLC RESET PDU or an RLC RESET ACK PDU, the RLC receiver discards all RLC SDUs that were transmitted before the reset in the transmitting side of the AM RLC entity. Following the RLC reset, before receiving a PDCP SeqNum PDU, a received PDCP Data PDU containing a compressed TCP packet is discarded. If a received PDCP Data PDU does not contain a compressed TCP packet, this received PDCP Data PDU may or may not be discarded. This embodiment of the present invention solves at least the problems of example 2.

Referring back to the second example above, header compression is applied and the data part in PDCP Data PDUs with SN=100, 101, 102, and 103 are compressed TCP packets. The header compression context of the decompressor is updated if the compressed data in the PDCP Data PDU is a compressed TCP packet and is decompressed successfully. The compressed TCP packet is a packet with a compressed TCP header, containing a CID, a flag octet identifying what fields have changed, and the changed fields (e.g. sequence number) encoded as the difference from the previous value.

Now, the RLC reset procedure is triggered and PDCP Data PDU with SN=100 and 101 are discarded. PDCP Data PDUs with SN=100 and 101 have been transmitted, but the receiving side of the peer RLC entity may or may not have received them correctly. Suppose that PDCP Data PDUs with SN=100 and 101 were not received correctly and RLC SDUs (PDCP Data PDUs with SN=102 and 103) that were not transmitted are not discarded. After the RLC reset, PDCP Data PDUs with SN=102 and 103 are transmitted first.

Because PDCP Data PDUs with SN=100 and 101 are lost, the header compression context in the decompressor in the PDCP receiver is not updated. The decompressor may compute the TCP checksum to determine if its context is not updated properly. If the checksum fails, the error is assumed to be caused by a lost segment that did not update the context properly. Therefore, if no mechanisms are applied, compressed TCP packets in PDCP Data PDUs with SN=102 and 103 are not decompressed successfully. An algorithm is used to repair the header compression context of the decompressor. The delta of the current segment is then added to the context again on the assumption that the lost segment contained the same delta as the current. By decompressing and computing the TCP checksum again, the decompressor checks if the repair succeeded or if the delta should be applied once more.

Because only two compressed TCP packets were lost, the algorithm should be able to used to decompress compressed TCP packets in PDCP Data PDUs with SN=102 and 103 successfully. Therefore, the header compression context of the decompressor is updated properly. The header compression context is updated according to fields in compressed TCP packets in PDCP Data PDUs with SN=102 and 103. Because the difference between changed fields in the current packet and the previous packet are positive, compressed TCP packets in PDCP SeqNum PDU with SN=100 and in PDCP Data PDU with SN=101 are not decompressed successfully and are lost forever. PDCP Data PDUs with SN=102 and 103 transmitted at the second time are not decompressed successfully. Moreover, the PDCP receiver sends context state packets to request the header compressor context of the PDCP sender due to the unsuccessful decompression. The PDCP sender sends its context contained in a packet (called full header packet) to the PDCP receiver. Transmission of context state packets and full header packets waste radio resources.

However, utilizing an embodiment of the present invention, for a radio bearer configured to support lossless SRNS Relocation, upon reception of an RLC RESET PDU or an RLC RESET ACK PDU, the RLC receiver discards all RLC SDUs that were transmitted before the reset in the transmitting side of the AM RLC entity. Following the RLC reset, before receiving a PDCP SeqNum PDU, a received PDCP Data PDU containing a compressed TCP packet is discarded. If a received PDCP Data PDU does not contain a compressed TCP packet, this received PDCP Data PDU may or may not be discarded. Therefore, compressed data are successfully decompressed and data are not lost, thus saving radio resources and improving performance.

In another embodiment of the present invention, for an AM radio bearer configured not to support lossless SRNS Relocation, upon reception of an RLC RESET PDU or an RLC RESET ACK PDU, the RLC receiver discards all RLC SDUs that were transmitted before the reset in the transmitting side of the AM RLC entity and does not discard all RLC SDUs that were not transmitted before the reset in the transmitting side of the AM RLC entity. This embodiment of the present invention solves at least the problems of example 3.

Referring back to the third example above, a radio bearer is configured not to support lossless SRNS Relocation. The PDCP entity submits PDCP Data PDUs with Sequence Number (SN)=100, 101, 102, and 103 to the RLC. PDCP Data PDU with SN=100 and 101 has been transmitted by the transmitting side of AM RLC entity but not positively acknowledged.

Now conditions for an RLC reset are fulfilled, and the RLC reset procedure is triggered. According to the conventional method, the RLC receiver discards all RLC SDUs that were transmitted before the reset in the transmitting side of the AM RLC entity. Therefore, PDCP Data PDU with SN=100 and 101 are discarded in the RLC buffer.

In the conventional method, how to handle RLC SDUs that were not transmitted before the reset in the transmitting side of the AM RLC entity is not specified. If RLC SDUs that were not transmitted before the reset in the transmitting side of the AM RLC entity are discarded, those RLC SDUs are lost forever because the PDCP entity does not retransmit them.

However, utilizing an embodiment of the present invention, for an AM radio bearer configured not to support lossless SRNS Relocation, upon reception of an RLC RESET PDU or an RLC RESET ACK PDU, the RLC receiver discards all RLC SDUs that were transmitted before the reset in the transmitting side of the AM RLC entity and does not discard all RLC SDUs that were not transmitted before the reset in the transmitting side of the AM RLC entity. Since RLC SDUs that were not transmitted before the reset were not discarded, data are not lost, thus saving radio resources and improving performance.

In another embodiment of the present invention, for an AM radio bearer configured not to support lossless SRNS Relocation, upon reception of an RLC RESET PDU or an RLC RESET ACK PDU, the RLC receiver does not discard all RLC SDUs that were transmitted and were not transmitted before the reset in the transmitting side of the AM RLC entity. This embodiment of the present invention solves at least the problems of example 3.

Referring back to the third example above, a radio bearer is configured not to support lossless SRNS Relocation. The PDCP entity submits PDCP Data PDUs with Sequence Number (SN)=100, 101, 102, and 103 to the RLC. PDCP Data PDU with SN=100 and 101 has been transmitted by the transmitting side of AM RLC entity but not positively acknowledged.

Now conditions for an RLC reset are fulfilled, and the RLC reset procedure is triggered. According to the conventional method, the RLC receiver discards all RLC SDUs that were transmitted before the reset in the transmitting side of the AM RLC entity. Therefore, PDCP Data PDU with SN=100 and 101 are discarded in the RLC buffer.

In the conventional method, how to handle RLC SDUs that were not transmitted before the reset in the transmitting side of the AM RLC entity is not specified. If RLC SDUs that were not transmitted before the reset in the transmitting side of the AM RLC entity are discarded, those RLC SDUs are lost forever because the PDCP entity does not retransmit them.

However, utilizing an embodiment of the present invention, for an AM radio bearer configured not to support lossless SRNS Relocation, upon reception of an RLC RESET PDU or an RLC RESET ACK PDU, the RLC receiver does not discard all RLC SDUs that were transmitted and were not transmitted before the reset in the transmitting side of the AM RLC entity. Since RLC SDUs that were not transmitted before the reset were not discarded, data are not lost, thus saving radio resources and improving performance.

In another embodiment of the present invention, for a radio bearer configured to support lossless SRNS Relocation, when the RLC entity is re-established by upper layers, the RLC entity discards all RLC SDUs that were transmitted and were not transmitted before the re-establishment in the transmitting side of the RLC entity.

In another embodiment of the present invention, for an AM radio bearer configured not to support lossless SRNS Relocation, when the RLC entity is re-established by upper layers, the RLC entity discards all RLC SDUs that were transmitted before the re-establishment in the transmitting side of the RLC entity. All RLC SDUs that were not transmitted before the re-establishment in the transmitting side of the RLC entity are not discarded. This embodiment of the present invention solves at least the problems of example 4.

Referring back to the fourth example above, an AM radio bearer is configured not to support lossless SRNS Relocation. The PDCP entity submits PDCP Data PDUs with SN=100, 101, 102, and 103 to the RLC. PDCP Data PDUs with SN=100 and 101 have been transmitted by the transmitting side of AM RLC entity but have not been positively acknowledged. Now, the RLC entity is re-established. According to the conventional method, the RLC entity discards all RLC PDUs and control PDUs so PDCP Data PDUs with SN=100, 101, 102, and 103 are discarded in the RLC buffer. PDCP Data PDUs with SN=102 and 103 are lost forever because the PDCP entity does not retransmit them.

However, utilizing an embodiment of the present invention, for an AM radio bearer configured not to support lossless SRNS Relocation, when the RLC entity is re-established by upper layers, the RLC entity discards all RLC SDUs that were transmitted before the re-establishment in the transmitting side of the RLC entity. All RLC SDUs that were not transmitted before the reestablishment in the transmitting side of the RLC entity are not discarded. Since all RLC SDUs that were not transmitted before the reset were not discarded, data are not lost, thus saving radio resources and improving performance.

In another embodiment of the present invention, for an AM radio bearer configured not to support lossless SRNS Relocation, when the RLC entity is re-established by upper layers, the RLC entity does not discard all RLC SDUs that were transmitted and were not transmitted before the re-establishment in the transmitting side of the RLC entity. This embodiment of the present invention solves at least the problems of example 4.

Referring back to the fourth example above, an AM radio bearer is configured not to support lossless SRNS Relocation. The PDCP entity submits PDCP Data PDUs with SN=100, 101, 102, and 103 to the RLC. PDCP Data PDUs with SN=100 and 101 have been transmitted by the transmitting side of AM RLC entity but have not been positively acknowledged. Now, the RLC entity is re-established. According to the conventional method, the RLC entity discards all RLC PDUs and control PDUs so PDCP Data PDUs with SN=100, 101, 102, and 103 are discarded in the RLC buffer. PDCP Data PDUs with SN=102 and 103 are lost forever because the PDCP entity does not retransmit them.

However, utilizing an embodiment of the present invention, for an AM radio bearer configured not to support lossless SRNS Relocation, when the RLC entity is re-established by upper layers, the RLC entity does not discard all RLC SDUs that were transmitted and were not transmitted before the re-establishment in the transmitting side of the RLC entity. Since all RLC SDUs are not discarded, data are not lost, thus saving radio resources and improving performance.

In another embodiment of the present invention, except RESET PDUs and RESET ACK PDUs, control PDUs are discarded during RLC reset.

As shown above, there is need for an improved scheme for efficiently handling actions taken so that inappropriate actions are avoided, data are not lost, errors are reduced, system resources are not wasted, and wireless communication system performance is improved.

Therefore, the present invention provides a method for specifying actions for handling an RLC RESET PDU or an RLC RESET ACK PDU which thereby improves wireless communication system performance, prevents data loss, and reduces wasting of system resources.

Note that the embodiments of the present invention described above are only examples. In other embodiments, various other steps or methods are utilized for handling resets or reset acknowledges without deviating from the scope of the present invention of specifying actions taken so that inappropriate actions are avoided and wireless communication system performance is improved.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. A method for improving wireless communication system performance comprising:
detecting a radio link control (RLC) reset event by an RLC entity; and
discarding all RLC service data units that were transmitted or were not transmitted before the reset in a transmitting side of the RLC entity.

2. The method for improving wireless communication system performance of claim 1, wherein detecting a radio link (RLC) reset event by an RLC entity is receiving a RESET Protocol Data Unit (PDU) by an RLC entity.

3. The method for improving wireless communication system performance of claim 1, wherein detecting a radio link (RLC) reset event by an RLC entity is receiving a RESET acknowledgement (ACK) Protocol Data Unit (PDU) by an RLC entity.

4. The method for improving wireless communication system performance of claim 1, wherein detecting a radio link (RLC) reset event by an RLC entity is detecting a condition for sending a RLC RESET Protocol Data Unit (PDU) by an RLC entity.

5. A method for improving wireless communication system performance comprising:
configuring a radio bearer to support lossless SRNS Relocation and header compression;
detecting a radio link control (RLC) reset event by an RLC entity; and
submitting a PDCP PDU containing a compressed packet by a PDCP entity;
whereby a first compressed packet type after an RLC reset procedure is a full header or compressed transmission control protocol (TCP) with no delta for a TCP packet stream.

6. The method for improving wireless communication system performance of claim 5, wherein detecting a radio link (RLC) reset event by an RLC entity is receiving a RESET Protocol Data Unit (PDU) by an RLC entity.

7. The method for improving wireless communication system performance of claim 5, wherein detecting a radio link (RLC) reset event by an RLC entity is receiving a RESET acknowledgement (ACK) Protocol Data Unit (PDU) by an RLC entity.

8. The method for improving wireless communication system performance of claim 5, wherein detecting a radio link (RLC) reset event by an RLC entity is detecting a condition for sending a RLC RESET Protocol Data Unit (PDU) by an RLC entity.

9. A method for improving wireless communication system performance comprising:
configuring a radio bearer to support lossless SRNS Relocation and header compression;
detecting a radio link control (RLC) reset event by an RLC entity;
whereby after the RLC reset procedure and before receiving a PDCP SeqNum PDU, a PDCP Data PDU containing a compressed TCP packet is received, the PDCP Data PDU containing a compressed TCP packet is discarded.

10. The method for improving wireless communication system performance of claim 9, wherein detecting a radio link (RLC) reset event by an RLC entity is receiving a RESET Protocol Data Unit (PDU) by an RLC entity.

11. The method for improving wireless communication system performance of claim 9, wherein detecting a radio link (RLC) reset event by an RLC entity is receiving a RESET acknowledgement (ACK) Protocol Data Unit (PDU) by an RLC entity.

12. The method for improving wireless communication system performance of claim 9, wherein detecting a radio link (RLC) reset event by an RLC entity is detecting a condition for sending a RLC RESET Protocol Data Unit (PDU) by an RLC entity.

13. A method for improving wireless communication system performance comprising:
configuring an acknowledged mode radio bearer to not support lossless SRNS Relocation;
detecting a radio link control (RLC) reset eventby an RLC entity; and
discarding all RLC service data units that were transmitted before the reset in a transmitting side of the RLC entity;
whereby all RLC service data units that were not transmitted before the reset in a transmitting side of the RLC entity are not discarded.

14. The method for improving wireless communication system performance of claim 13, wherein detecting a radio link (RLC) reset event by an RLC entity is receiving a RESET Protocol Data Unit (PDU) by an RLC entity.

15. The method for improving wireless communication system performance of claim 13, wherein detecting a radio link (RLC) reset event by an RLC entity is receiving a RESET acknowledgement (ACK) Protocol Data Unit (PDU) by an RLC entity.

16. The method for improving wireless communication system performance of claim 13, wherein detecting a radio link (RLC) reset event by an RLC entity is detecting a condition for sending a RLC RESET Protocol Data Unit (PDU) by an RLC entity.

17. A method for improving wireless communication system performance comprising:
configuring an acknowledged mode radio bearer to not support lossless SRNS Relocation; and
detecting a radio link control (RLC) reset eventby an RLC entity;
whereby all RLC service data units that were transmitted or were not transmitted by a transmitting side of the RLC entity before the reset are not discarded by the RLC entity.

18. The method for improving wireless communication system performance of claim 17, wherein detecting a radio link (RLC) reset event by an RLC entity is receiving a RESET Protocol Data Unit (PDU) by an RLC entity.

19. The method for improving wireless communication system performance of claim 17, wherein detecting a radio link (RLC) reset event by an RLC entity is receiving a RESET acknowledgement (ACK) Protocol Data Unit (PDU) by an RLC entity.

20. The method for improving wireless communication system performance of claim 17, wherein detecting a radio link (RLC) reset event by an RLC entity is detecting a condition for sending a RLC RESET Protocol Data Unit (PDU) by an RLC entity.

21. A method for improving wireless communication system performance comprising:
configuring an acknowledged mode radio bearer to support lossless SRNS Relocation;
re-establishing an RLC entity by an upper layer; and
discarding all RLC SDUs by the RLC entity that were transmitted or were not transmitted before the RLC entity was re-established.

22. A method for improving wireless communication system performance comprising:
configuring an acknowledged mode radio bearer to not support lossless SRNS Relocation;
re-establishing an RLC entity by an upper layer; and
discarding no RLC SDUs by the RLC entity that were transmitted or were not transmitted before the RLC entity was re-established.

23. A method for improving wireless communication system performance comprising:
detecting a radio link control (RLC) reset event by an RLC entity; and
discarding all control PDUs except for RESET PDUs and RESET ACK PDUs by the RLC entity;

24. The method for improving wireless communication system performance of claim 23, wherein detecting a radio link (RLC) reset event by an RLC entity is receiving a RESET Protocol Data Unit (PDU) by an RLC entity.

25. The method for improving wireless communication system performance of claim 23, wherein detecting a radio link (RLC) reset event by an RLC entity is receiving a RESET acknowledgement (ACK) Protocol Data Unit (PDU) by an RLC entity.

26. The method for improving wireless communication system performance of claim 23, wherein detecting a radio link (RLC) reset event by an RLC entity is detecting a condition for sending a RLC RESET Protocol Data Unit (PDU) by an RLC entity.
